(19) United States
(12) Patent Application Publication
(10) Pub. No.: US 2004/0199676 A1
(43) Pub. Date: Oct. 7, 2004

(54) Electronic peripheral device and network card

(75) Inventors: Chun-Chin Chen, Taoyuan City (TW); Chia-Ching Chai, Banchiau City (TW); Chang-Hung Lee, Yunlin (TW)

Correspondence Address: Richard P. Berg. Esq., c/o LADAS & PARRY, 5670 Wilshire Boulevard, Suite 2100, Los Angeles, CA, 90036-5679, US

(73) Assignee: BENQ CORPORATION

(21) Appl. No.: 10/794,278

(22) Filed: Mar. 4, 2004

(30) Foreign Application Priority Data
Mar. 11, 2003 (TW) 92105171

(51) Int. Cl. G06F 3/00

(52) U.S. Cl. 710/1

(57) ABSTRACT

A electronic peripheral device. The electronic peripheral device is coupled to an electronic system. The electronic peripheral device comprises a peripheral module, a storage module and an interface multiplexer. The peripheral module may be a network access module through which the electronic system accesses a network. The storage module stores a driver for the network access module. Via the interface multiplexer, the electronic system is selectively coupled to either the network access module or the storage module to establish data transmission between the network access module or the storage module and the electronic system. When the electronic peripheral device is coupled to the electronic system at the first time, the electronic system is coupled to the storage module through the interface multiplexer first.

### BACKGROUND OF THE INVENTION

1. Field of the Invention

The present invention relates to an electronic device and particularly to an electronic peripheral device coupled to an electronic system. The electronic system can directly access the electronic peripheral device without installing a driver from other peripheral devices.

2. Description of the Prior Art

A number of wireless network technologies have been proposed during the past few years. New radio access technologies and wireless network standards are also being developed. According to different requirements, electronic systems such as personal computers, notebooks, or PDAs can connect to different wireless networks via different electronic peripheral devices such as a network card. For example, with a wireless local area network (Wireless LAN, WLAN) card, a notebook can connect to a wireless local network.

Interfaces of access points in the WLAN network roughly comprise a Personal Computer Memory Card International Association (PCMCIA) interface, a Universal Serial Bus (USB) interface or a MiniPCI interface. USB boxes and USB sticks belong to the USB interface. The MiniPCL interface is built into a notebook. Thus, users need not install the driver for the MiniPCL interface. For other interfaces, drivers must be installed before using them. To install drivers, users must carry a storage device containing the drivers, such as a CD-ROM drive to read the storage device, all of which presents considerable inconvenience.

### SUMMARY OF THE INVENTION

The object of the present invention is to provide an electronic peripheral device, such that an electronic system coupled thereto can directly access the electronic peripheral device without installing a driver from other peripheral devices. Thus, convenience is increased.

The present invention provides an electronic peripheral device. The electronic peripheral device is coupled to an electronic system. The electronic peripheral device comprises a peripheral module, a storage module and an interface multiplexer. The peripheral module may be a network access module through which the electronic system accesses a network or a MP3 player for playing music. The storage module stores a driver or installation programs for the peripheral module. Via the interface multiplexer, the electronic system is selectively coupled to either the peripheral module or the storage module to establish data transmission between the peripheral module or the storage module and the electronic system. When the electronic peripheral device is coupled to the electronic system at the first time, the electronic system is coupled to the storage module through the interface multiplexer first.

When the electronic system needs to install a driver for the peripheral module, the electronic system reads the driver corresponding to the peripheral module stored in the storage module via the interface multiplexer. The storage module comprises a storage element and a processor. The storage element stores the driver. The processor controls data access from the storage element and transmits data stored in the storage element to the electronic system.

### BRIEF DESCRIPTION OF THE DRAWINGS

The present invention will become more fully understood from the detailed description given below and the accompanying drawings, given by way of illustration only and thus not intended to be limitative of the present invention.

FIG. 1 is a diagram illustrating a configuration of an electronic peripheral device and an electronic system coupled to the electronic peripheral device in the present invention.

FIG. 2 is a diagram illustrating a configuration of an electronic peripheral device and an electronic system coupled to the electronic peripheral device according to the first embodiment of the present invention.

FIG. 3 is a diagram illustrating a configuration of a network card and an electronic system coupled to the electronic peripheral device according to the second embodiment of the present invention.

### DETAILED DESCRIPTION OF THE INVENTION

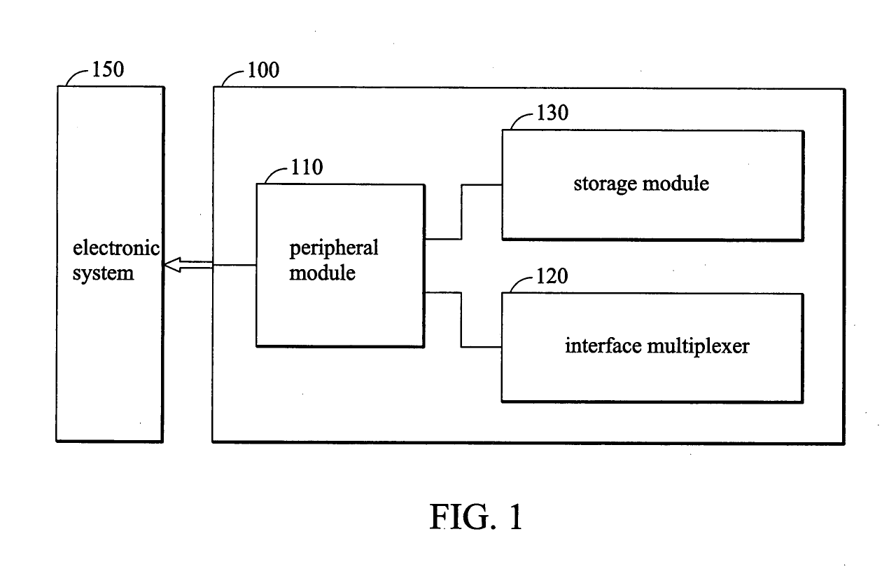

FIG. 1 is a diagram illustrating a configuration of an electronic peripheral device and an electronic system coupled to the electronic peripheral device in the present invention. As shown in FIG. 1, the electronic peripheral device 100 is coupled to an electronic system 150. The electronic peripheral device 100 comprises a peripheral module 120, a storage module 130 and an interface multiplexer 110. The peripheral module 120 is providing extra functions of the electronic system 150. For example, the peripheral module 120 may be a network access module through which the electronic system 150 can access a network or a MP3 player with which the electronic system 150 can play music. The storage module 130 stores a driver or installation programs for the peripheral module 120. Via the interface multiplexer 110, the electronic system 150 is selectively coupled to either the peripheral module 120 or the storage module 130 to establish data transmission between the peripheral module 120 or the storage module 130 and the electronic system 150. When the electronic peripheral device 100 is coupled to the electronic system 150 at the first time, the electronic system 150 is coupled to the storage module 130 through the interface multiplexer 110 to read the driver for the peripheral module 120 first.

An electronic peripheral device coupled to the WLAN network is used as an example to illustrate an embodiment of the present invention.

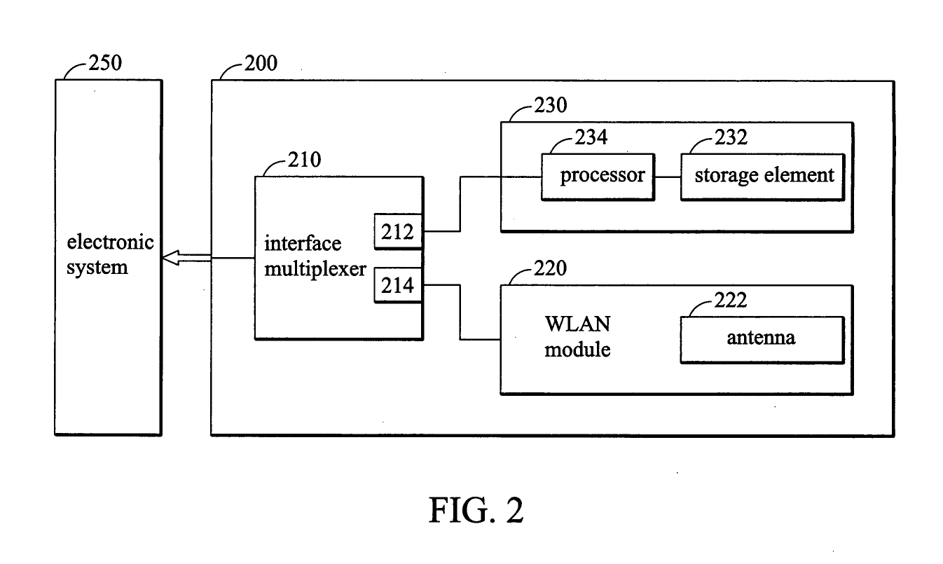

FIG. 2 is a diagram illustrating a configuration of an electronic peripheral device and an electronic system coupled to the electronic peripheral device according to the first embodiment of the present invention. As shown in FIG. 2, the electronic peripheral device 200 can connect to the electronic system 250 such as a personal computer, a notebook, or a PDA via different interfaces. If the electronic system 250 connects to the WLAN network through the electronic peripheral device 200, the connecting interface between the electronic peripheral device 200 and the electronic system 250 may be a PCMCIA interface, a USB interface or a MiniPCI interface. USB interfaces are roughly categorized into USB boxes and USB sticks.

The electronic peripheral device 200 comprises a WLAN module 220, a storage module 230 and an interface multiplexer 210. By the WLAN module 220, the electronic system 250 can access the WLAN network (not shown in FIG. 2). The WLAN module 220 comprises at least an antenna 222 for transmitting and receiving wireless signals. The WLAN module 220 is similar to wireless network cards. The wireless LAN cards are usually provided by different companies. When plugging a wireless LAN card into a personal computer, if the driver is not in the group of preset WLAN drivers in the personal computer, the operation system detects the card plugging in and asks user providing the directory of the driver saved.

The storage module 230 comprises a storage element 232 and a processor 234. For example, storage module 230 can be a USB flash disk module which provides plug and play functions. As the USB flash disk is widely used, their drivers are commonly provided by the operation system of the personal computer. Most of the flash disks can be plugged into the personal computer and installed automatic and ready be used. The storage element 232 stores a driver or installation programs for the WLAN module 220. The processor 234 controls data access from the storage element 232 and transmits data stored in the storage element 232 to the electronic system 250.

The interface multiplexer 210 comprises a first port 212 and a second port 214, for example multiplexer 210 can be a internal 2-port USB hub. The storage module 230 is coupled to the first port 212. The WLAN module 220 is coupled to the second port 214. When the electronic peripheral device 200 is coupled to the electronic system 250, the electronic system 250 installs the storage module 230 coupled to the first port 212 first, then installs the network access module 220 coupled to the second port 214 via the interface multiplexer 210.

Via the interface multiplexer 210, the electronic system 250 is selectively coupled to either the WLAN module 220 or the storage module 230 to establish data transmission between the network access module 220 or the storage module 230 and the electronic system 250. When the electronic peripheral device 200 is coupled to the electronic system 250 at the first time, the electronic system 250 is coupled to the storage module 230 through the first port 212 of the interface multiplexer 210 and installed the storage module 230 by drivers stored in the electronic system 250. Then the electronic system 250 is coupled to the network access module 220 through the second port 214 of the interface multiplexer 210 and installed the network access module 220 by drivers stored in the storage module 230.

The electronic peripheral device of the present invention may connect networks, such as a network card. A network card coupled to the WLAN network is used as an example to illustrate another embodiment of the present invention.

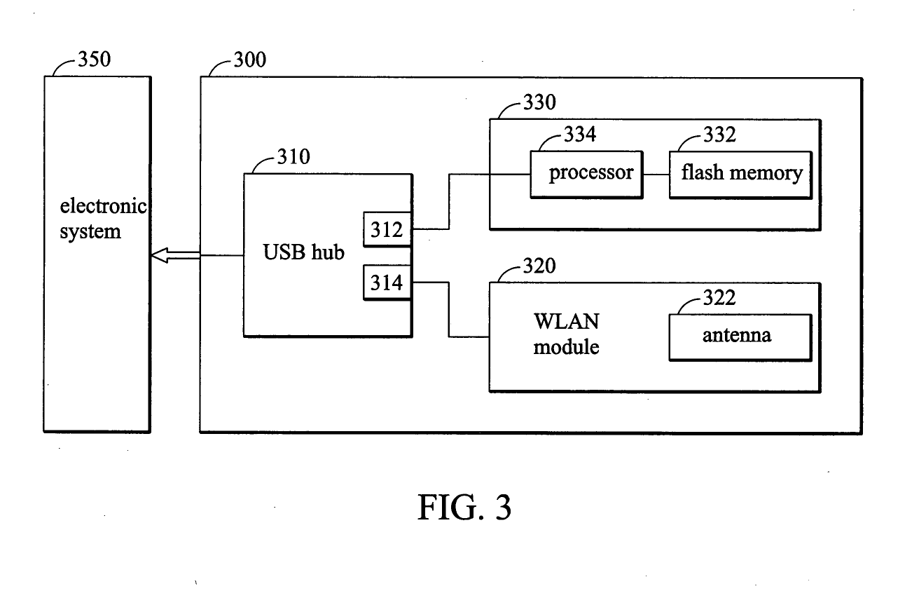

FIG. 3 is a diagram illustrating a configuration of a network card and an electronic system coupled to the electronic peripheral device according to the second embodiment of the present invention. As shown in FIG. 3, the network card 300 connects to the electronic system 350 such as a personal computer, a notebook, or a PDA via a USB stick.

The network card 300 comprises a WLAN module 320, a storage module 330 and a USB hub 310. By the WLAN module 320, the electronic system 350 can access the WLAN network (not shown in FIG. 3). The WLAN module 320 comprises at least an antenna 322 for transmitting and receiving wireless signals.

The storage module 33 comprises a flash memory 332 and a processor 334. The flash memory 332 stores a driver for the WLAN module 320. The processor 334 controls data access from the flash memory 332 and transmits data stored in the flash memory 332 to the electronic system 350.

The USB hub 310 comprises a first port 312 and a second port 314, the first port 312 has higher priority than the second port 314 for installation. The storage module 330 is coupled to the first port 312. The WLAN module 320 is coupled to the second port 314. When the network card 300 is coupled to the electronic system 350, the electronic system 350 installs the storage module 330 coupled to the first port 312 first, then installs the network access module 320 coupled to the second port 314 via the USB hub 310.

Via the USB hub 310, the electronic system 350 is selectively coupled to either the WLAN module 320 or the storage module 330 to establish data transmission between the network access module 320 or the storage module 230 and the electronic system 350. When the network card 300 is coupled to the electronic system 350 at the first time, the electronic system 350 is coupled to the storage module 330 through the USB hub 310 to read the driver first.

After accomplishing the driving procedure for the first time, users can selectively set the WLAN module 320 to start to access the WLAN network automatically or semi-automatically.

In the present invention, the flash memory is taken as an example to store the driver for the WLAN module. In other embodiments, other storage devices can replace the flash memory. Furthermore, the USB stick is taken as an example of the connecting interface between the network card and the electronic system. In other embodiments, other interfaces such as a PCIMCAI interface, a UBS box or a MiniPCI interface can replace the USB stick. If the connecting interface is changed, other interface multiplexers suitable for the new connecting interface must replace the USB hub.

By the electronic peripheral device provided by the present invention, an electronic system coupled to the electronic peripheral device can connect to a network without installing a driver from other peripheral devices. Thus, convenience is increased.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. An electronic peripheral device for coupling to an electronic system comprising:
a peripheral module for providing extra functions to the electronic system;
a storage module for storing a driver corresponding to the peripheral module; and
an interface multiplexer, the electronic system selectively establishing data transmission to the peripheral module and the storage module through the interface multiplexer.

2. The electronic peripheral device as claimed in claim 1, wherein the peripheral module is a network access module through which the electronic system accesses a network.

3. The electronic peripheral device as claimed in claim 1, wherein when the electronic peripheral device is coupled to the electronic system at the first time, the electronic system is coupled to the storage module through the interface multiplexer first.

4. The electronic peripheral device as claimed in claim 1, wherein when the electronic system needs to install a driver for the peripheral module, the electronic system reads the driver stored in the storage module via the interface multiplexer.

5. The electronic peripheral device as claimed in claim 2, wherein the network access module is a module for accessing a wireless LAN.

6. The electronic peripheral device as claimed in claim 5, the module for accessing the wireless LAN comprising an antenna for transmitting and receiving wireless signals.

7. The electronic peripheral device as claimed in claim 1, wherein the storage module comprises:
a storage element for storing the driver;
a processor for controlling data access from the storage element and transmitting data stored in the storage element to the electronic system.

8. The electronic peripheral device as claimed in claim 7, wherein the storage element is a flash memory.

9. The electronic peripheral device as claimed in claim 1, wherein the interface multiplexer is a USB hub with a first port and a second port.

10. The electronic peripheral device as claimed in claim 9, wherein the storage module is coupled to the first port of the USB hub and the peripheral module is coupled to the second port of the USB hub.

11. The electronic peripheral device as claimed in claim 1, wherein the interface multiplexer comprises a first port and a second port, the storage module is coupled to the first port, the peripheral module is coupled to the second port, and when the electronic peripheral device is coupled to the electronic system, the electronic system installs the storage module and the peripheral module in order via the interface multiplexer.

12. The electronic peripheral device as claimed in claim 11, the electronic system installing the storage module by a preset driver in the electronic system.

13. The electronic peripheral device as claimed in claim 11, the electronic system installing the peripheral module by the driver in the storage module.

14. A network card for a electronic system to access a network comprising:
a network access module;
a storage module for storing a driver for the network access module; and
an interface multiplexer, the electronic system selectively establishing data transmission to the network access module and the storage module through the interface multiplexer.

15. The network card as claimed in claim 14, wherein when the network card is coupled to the electronic system at the first time, the electronic system is coupled to the storage module through the interface multiplexer first.

16. The network card as claimed in claim 14, wherein when the network access module needed to be installed, the electronic system read the driver stored in the storage module through the interface multiplexer.

17. The network card as claimed in claim 14, wherein the network access module is a module for accessing a wireless LAN.

18. The network card as claimed in claim 14, wherein the storage module comprises:
a storage element for storing the driver;
a processor for controlling data access from the storage element and transmitting data stored in the storage element to the electronic system.

19. The network card as claimed in claim 18, wherein the storage element is a flash memory.

20. The network card as claimed in claim 14, wherein the interface multiplexer is a USB hub with a first port and a second port.

21. The network card as claimed in claim 20, wherein the storage module is coupled to the first port of the USB hub and the network access module is coupled to the second port of the USB hub.

22. The network card as claimed in claim 14, wherein the interface multiplexer comprises a first port and a second port, the storage module is coupled to the first port, the network access module is coupled to the second port, and when the electronic peripheral device is coupled to the electronic system, the electronic system installs the storage module and the network access module in order via the interface multiplexer.
